(19) United States
(12) Patent Application Publication
(10) Pub. No.: US 2025/0278580 A1
(43) Pub. Date: Sep. 4, 2025

(54) System and Method for Adjusting Search Strategy Based on Patent Classification Translation

(71) Applicants: SQ Technology (Shanghai) Corporation, Shanghai (CN); Inventec Corporation, Taipei City (TW)

(72) Inventor: Chuan-Cheng Chiu, Taipei City (TW)

(21) Appl. No.: 18/611,301

(22) Filed: Mar. 20, 2024

(30) Foreign Application Priority Data
Mar. 1, 2024 (CN) 202410239569.7

(51) Int. Cl. G06F 40/42; G06F 16/35

(52) U.S. Cl. CPC G06F 40/42; G06F 16/353

(57) ABSTRACT

A system and a method for adjusting a search strategy based on patent classification translation are disclosed. In the system, an operation-end device receives a preliminary search strategy. The system searches matching patent data from a patent database, and extracts a patent classification from the searched patent data. The operation-end device is permitted to label the patent classification. It searches a classification definition description message corresponding to the labelled patent classification. Afterwards, it executes a natural language processing on the classification definition description message to perform tokenization and sentence segmentation, to filter out the technical phrase having a proper noun, so that the technical phrase can be translated into an idiomatic sentence based on a translation table. The translated idiomatic sentence can be combined with the preliminary search strategy to automatically form an advanced search strategy, thereby achieving a technical effect of improving an accuracy of patent search.

### CROSS-REFERENCE TO RELATED APPLICATION

This application claims the benefit of Chinese Application Serial No. 202410239569.7, filed Mar. 1, 2024, which is hereby incorporated herein by reference in its entirety.

### BACKGROUND OF THE INVENTION

### 1. Field of the Invention

The present invention relates to a system and method of adjusting search strategy, and more particularly to a system and a method for adjusting search strategy based on patent classification translation.

### 2. Description of the Related Art

In recent years, with the popularity and vigorous development of innovative industries, various innovative industries have sprung up; however, how to avoid infringing on existing patents has always been one of the issues that manufacturers are eager to solve. Therefore, how to perform patent search accurately has attracted much attention.

Generally, a conventional patent search method relies on practical experience and iterative convergence processes to generate appropriate search strategies. However, the conventional method often consumes a lot of time, and it may not be possible to obtain a suitable search strategy. On the other hand, searchers with practical experience may use patent classification to narrow the search scope, but the patent classification is highly subjectively affected by the patent examiner, and the patent classification often cannot express intuitive technical terms. Therefore, the conventional patent search method has the problem that it is difficult to issue an appropriate patent search strategy, so there is an urgent need for a solution that automatically generates an appropriate patent search strategy.

According to above-mentioned contents, what is needed is to develop an improved solution to solve the problem that it is difficult to issue an appropriate patent search strategy.

### SUMMARY OF THE INVENTION

An objective of the present invention is to disclose a system for adjusting search strategy based on patent classification translation and a method thereof, so as to solve the above-mentioned conventional problem.

In order to achieve the objective, the present invention discloses a system for adjusting search strategy based on patent classification translation, and the system includes a patent database and an operation-end device. The patent database is configured to store pieces of patent data. The operation-end device is connected to the patent database through network, and the operation-end device includes a non-transitory computer readable storage medium and a hardware processor. The non-transitory computer readable storage medium is configured to store computer readable instructions. The hardware processor, electrically connected to the non-transitory computer readable storage medium, and configured to execute the computer readable instructions to make the operation-end device execute: receiving a preliminary search strategy, and transmitting the preliminary search strategy to the patent database to search one of the pieces of patent data matching the preliminary search strategy, and extracting at least one patent classification from the searched one of the pieces of patent data;
permitting to label the patent classification and query a classification definition description message corresponding to the labelled patent classification, and executing a natural language processing on the classification definition description message, to perform a tokenization and sentence segmentation to generate phrases; analyzing a technical field corresponding to the patent classification, and filtering out the phrase having a proper noun of the technical field to be at least one technical phrase; based on a translation table, translating the at least one technical phrase to at least one idiomatic sentence, selecting at least one of the at least one idiomatic sentence, and combine the selected idiomatic sentence with the preliminary search strategy to form an advanced search strategy; executing search on the pieces of patent data based on the advanced search strategy, to filter out at least one piece of accurate patent data.

In order to achieve the objective, the present invention discloses a method for adjusting search strategy based on patent classification translation, and the method include steps of: connecting a patent database and an operation-end device through network, wherein the patent database stores pieces of patent data, the operation-end device includes a non-transitory computer readable storage medium storing computer readable instructions, and a hardware processor configured to execute the computer readable instructions; receiving a preliminary search strategy, and transmitting the preliminary search strategy to the patent database to search one of the pieces of patent data matching the preliminary search strategy, extracting at least one patent classification from the searched one of the pieces of patent data, by the operation-end device; permitting the operation-end device to label the patent classification, query a classification definition description message corresponding to the labelled patent classification, and execute a natural language processing on the classification definition description message to perform the tokenization and sentence segmentation to generate phrases; analyzing a technical field corresponding to the patent classification, and filtering out the phrase having a proper noun of the technical field to be at least one technical phrase, by the operation-end device; based on a translation table, translating the technical phrase to at least one idiomatic sentence, select at least one of the at least one idiomatic sentence, and combine the selected idiomatic sentence with the preliminary search strategy to form an advanced search strategy, by the operation-end device; performing search on the pieces of patent data based on the advanced search strategy again, to filter at least one piece of accurate patent data, by the operation-end device.

According to the above-mentioned system and method of the present invention, the difference between the present invention and the conventional technology is that the operation-end device 120 can receive the preliminary search strategy, search the matching patent data from the patent database, and extract the patent classification from the searched patent data; the operation-end device is permitted to label the patent classification, and search the classification definition description message corresponding to the labelled patent classification, execute a natural language processing on the classification definition description message to perform tokenization and sentence segmentation, to filter out the technical phrase having the proper noun, so that the technical phrase can be translated into the idiomatic sentence based on the translation table, and the translated idiomatic sentence can be combined with the preliminary search strategy to automatically form an advanced search strategy, thereby achieving a technical effect of improving an accuracy of patent search.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a system for adjusting a search strategy based on patent classification translation, according to the present invention.

FIG. 2A and FIG. 2B are flowcharts of a method for adjusting a search strategy based on patent classification translation, according to the present invention.

FIG. 3A and FIG. 3B are schematic views of a preliminary search and translation, according to an application of the present invention.

FIG. 4 is a schematic view of a patent search based on an advanced search strategy, according to an application of the present invention.

FIG. 5 is a schematic view of an operation of generating and updating a translation table, according to an application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions, and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first,’ ‘second,’ ‘third,’ and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include,” and variations such as “comprises,” “comprising,” “includes,” or “including,” will be acknowledged to imply the inclusion of stated elements but not the exclusion of any other elements.

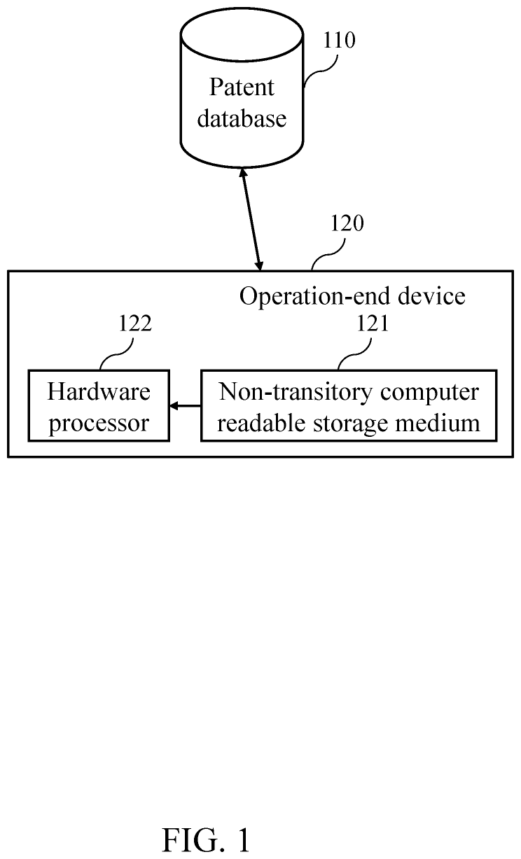

Please refer to FIG. 1. FIG. 1 is a block diagram of a system for adjusting search strategy based on patent classification translation, according to the present invention. The system includes a patent database 110 and an operation-end device 120. The patent database 110 is configured to store pieces of patent data. In actual implementation, the patent database 110 can be built by a user, or integrate databases provided by patent agencies of various countries, to provide the user to search raw data of patents, such as bibliographic data of patent.

The operation-end device 120 is connected to the patent database 110 through network and includes a non-transitory computer readable storage medium 121 and a hardware processor 122. The non-transitory computer readable storage medium 121 is configured to store computer readable instructions. In actual implementation, the non-transitory computer-readable storage medium 121 may include a floppy disk, a hard disk, an optical disk, a flash memory, or the like. The computer readable instructions can be assembly language instructions, instruction-set-structure instructions, machine instructions, machine-related Instructions, micro-instructions, firmware instructions, or source codes or object codes written in any combination of one or more programming languages. The programming language includes object-oriented programming languages, such as: Common Lisp, Python, C++, Objective-C, Smalltalk, Delphi, Java, Swift, C#, Perl, Ruby, or PHP; the programming language can include regular procedural programming languages, such as C language or similar programming languages.

The hardware processor 122 is electrically connected to the non-transitory computer readable storage medium 121, and configured to execute the computer readable instructions to make the operation-end device 120 execute the following operations of: receiving a preliminary search strategy, transmitting the preliminary search strategy to the patent database 110 to search one of the pieces of patent data matching the preliminary search strategy, and extracting a patent classification from the searched one of the pieces of patent data; permitting to label the patent classification, querying a classification definition description message corresponding to the labelled patent classification, and executing a natural language processing on the classification definition description message, to perform tokenization and sentence segmentation to generate phrases; analyzing a technical field corresponding to the patent classification, and filtering out the phrase having a proper noun of the technical field, to be a technical phrase; based on a translation table, translating the technical phrase to an idiomatic sentence, selecting at least one of the idiomatic sentences, and combining the selected idiomatic sentence with the preliminary search strategy to form an advanced search strategy; performing a patent search on the pieces of patent data based on the advanced search strategy again, to filter at least one piece of accurate patent data. In actual implementation, the hardware processor 122 can be implemented by an integrated circuit chip, a system on chip (SoC), a field programmable gate array (FPGA), a complex programmable logic device (CPLD) or the like. The patent classification can be labelled by at least one of an automatic manner and a manual manner, so that the hardware processor 122 can execute the natural language processing (such as tokenization and sentence segmentation) on the assigned classification definition description message. The manual manner of labelling the patent classification is taken as example, a user can select a patent classification through a cursor; the automatic manner of labelling the patent classification is taken as example, the cumulative quantity of the same patent classification can be collected, and the patent classification having the highest cumulative quantity can be selected to label. It is to be particularly noted that the present invention is not limited to the above-mentioned exemplary manner of labelling the patent classification, and an embodiment with any manner of labelling the patent classification can be made by those skilled in the art without departing from the application field of the present invention. For example, the patent classification with the lowest cumulative quantity can be selected to label, or one of the patent classifications can be selected randomly to label.

According to above-mentioned content, the hardware processor 122 transmits the technical phrase to the large language model, requests the large language model to transmit back the corresponding idiomatic sentence, and generates and updates the translation table based on the technical phrase and the corresponding idiomatic sentence. For example, in a condition that the technical phrase is “verify user identity”, after the technical phrase is transmitted to the large language model, the obtained idiomatic sentence is “real-name identity”, in this case, the hardware processor 122 corresponds the technical phrase “verify user identity” to the obtained idiomatic sentence “real-name identity”, and store them to a table as a translation table, so that “verify user identity” can be translated into “real-name identity” by querying the translation table. Besides the above-mentioned manner, a user is permitted to freely label a technical phrase and input a corresponding idiomatic sentence through a cursor or shortcut key, so as to generate and update the translation table. It is to be particularly noted that the translation table is permitted to share, and the translation table generated and updated by different manners are permitted to synchronize with each other. In addition, the idiomatic sentence and the preliminary search strategy are combined as the advanced search strategy through a logical operator and a field code of bibliographic data of patent; for example, when the idiomatic sentence is “real-name identity”, and the preliminary search strategy is (metaverse)@AB, them can be combined as an advanced search strategy: (metaverse)@AB AND (“real-name identity”). The term “@AB” in the preliminary search strategy is regarded as the search limited in the abstract field of the bibliographic data of patent.

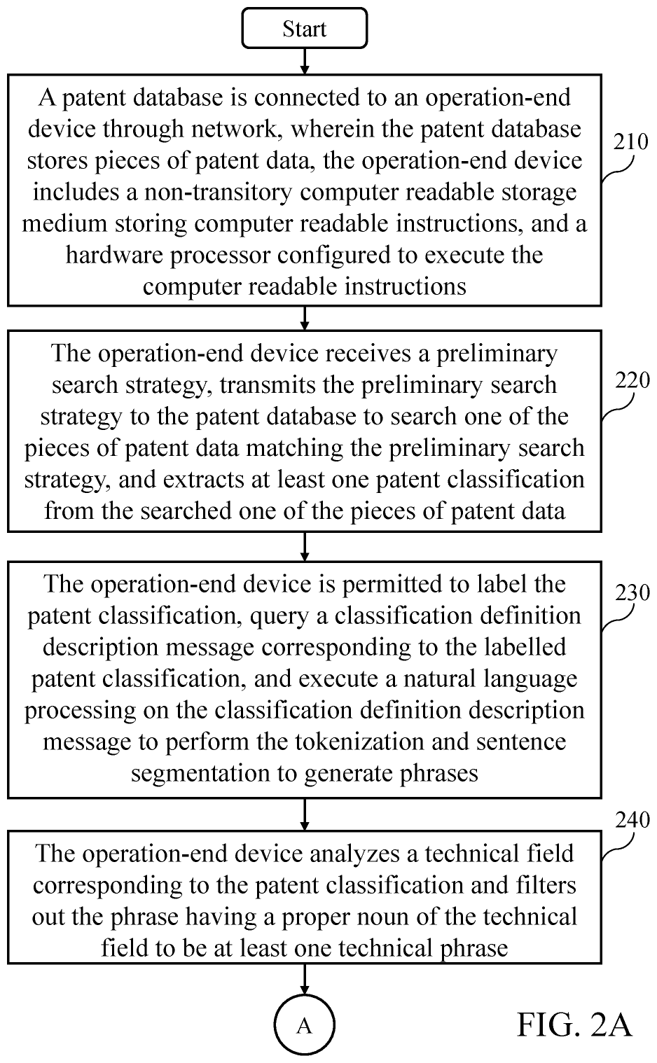

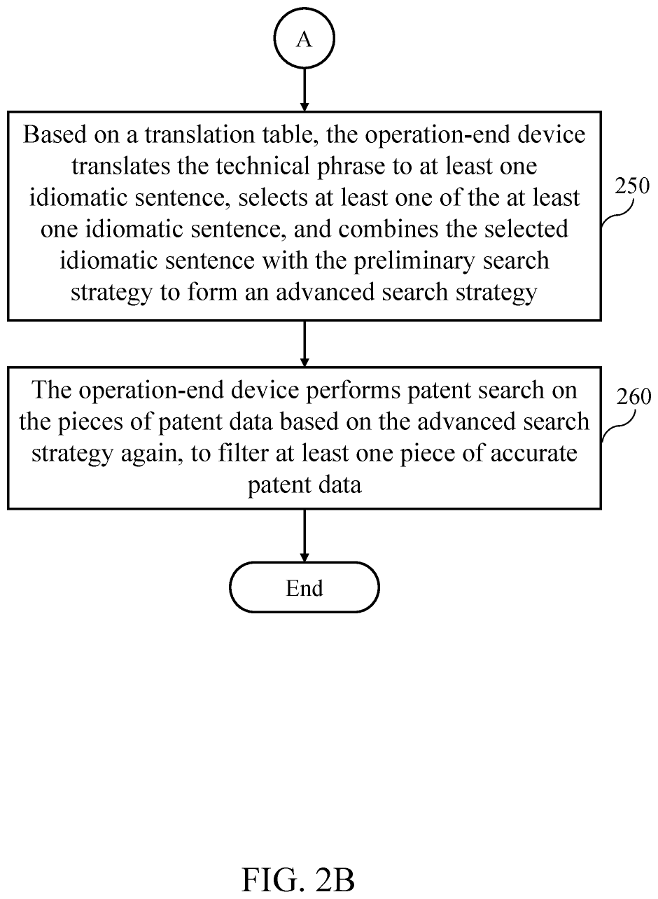

Please refer to FIG. 2A and FIG. 2B. FIG. 2A and FIG. 2B are flowcharts of a method for adjusting search strategy based on patent classification translation, according to the present invention. As shown in FIG. 2A and FIG. 2B, the method can include the following steps 210 to 260. In a step 210, a patent database 110 is connected to an operation-end device 120 through network, wherein the patent database 110 stores pieces of patent data, the operation-end device 120 includes a non-transitory computer readable storage medium storing computer readable instructions 121, and a hardware processor 122 configured to execute the computer readable instructions. In a step 220, the operation-end device 120 receives a preliminary search strategy, and transmits the preliminary search strategy to the patent database 110 to search one of the pieces of patent data matching the preliminary search strategy, and extracts at least one patent classification from the searched one of the pieces of patent data. In a step 230, the operation-end device 120 is permitted to label the patent classification, query a classification definition description message corresponding to the labelled patent classification, and execute a natural language processing on the classification definition description message to perform the tokenization and sentence segmentation to generate phrases. In a step 240, the operation-end device 120 analyzes a technical field corresponding to the patent classification, and filters out the phrase having a proper noun of the technical field to be at least one technical phrase. In a step 250, based on a translation table, the operation-end device 120 translates the technical phrase to at least one idiomatic sentence, selects at least one of the at least one idiomatic sentence, and combines the selected idiomatic sentence with the preliminary search strategy to form an advanced search strategy. In a step 260, the operation-end device 120 performs patent search on the pieces of patent data based on the advanced search strategy again, to filter at least one piece of accurate patent data. Through aforementioned steps, the operation-end device 120 can receive the preliminary search strategy, search the matching patent data from the patent database, and extract the patent classification from the searched patent data; the operation-end device is permitted to label the patent classification, and search the classification definition description message corresponding to the labelled patent classification, execute a natural language processing on the classification definition description message to perform tokenization and sentence segmentation, to filter out the technical phrase having the proper noun, so that the technical phrase can be translated into the idiomatic sentence based on the translation table, and the translated idiomatic sentence can be combined with the preliminary search strategy to automatically form an advanced search strategy.

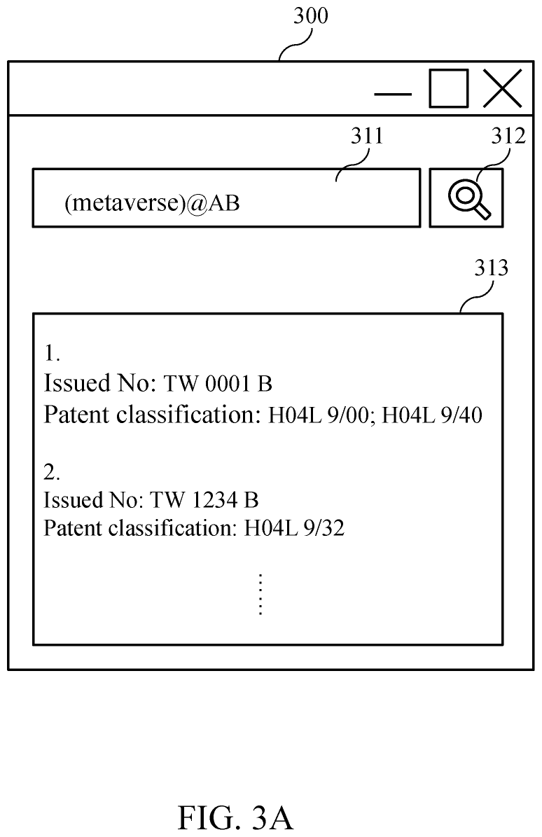

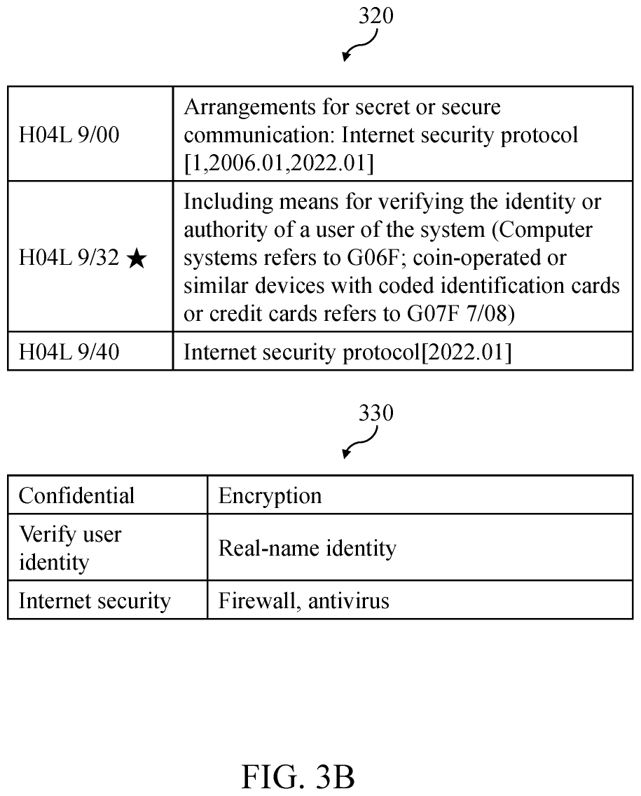

An embodiment of the present invention will be illustrated in the following paragraphs with reference to FIG. 3A to FIG. 5. Please refer to FIG. 3A and FIG. 3B. FIG. 3A and FIG. 3B are schematic views of a preliminary search and translation, according to an application of the present invention. In actual implementation, when a user wants to perform a patent search, the user can open a search window 300 and inputs a preliminary search condition (such as (metaverse)@AB) in an input block 311. Next, the user can click a search button 312 to transmit the preliminary search condition to the patent database, to search one of the pieces of patent data matching the preliminary search condition, and the searched patent data can be displayed on a display block 313. The operation-end device 120 then can extract the patent classification (such as IPC, UPC or other similar patent classification) from the searched patent data. In this case, as shown in FIG. 3B, the operation-end device 120 can query the extracted patent classification and the corresponding classification definition description message to form a patent classification table 320, and the user is permitted to label the extracted patent classification to select the patent classification. When the patent classification labelled by the user is “H04L 9/32” (as shown in FIG. 3B, the star symbol represents the labelled patent classification), the operation-end device 120 queries the classification definition description message corresponding to the labelled patent classification, and execute a natural language processing on the classification definition description message, to perform tokenization and sentence segmentation to generate plurality of phrases. For example, in a condition that the classification definition description message is “includes configured to verify user identity”, the phrases generated after the tokenization and sentence segmentation can include “includes”, “configured to” “verify user identity”. Similarly, when the user labels the patent classification such as H04L 9/00 or H04L 9/40, the operation-end device 120 performs tokenization and sentence segmentation on the corresponding classification definition description message.

The operation-end device 120 analyzes the technical field corresponding to the patent classification, filters out the phrase having a proper noun of the same technical field as the technical phrase, the above-mentioned generated phrases can include “includes” “configured to” and “verify user identity”. The phrase (such as “verify user identity”) having a proper noun (such as “verify”) can be filtered out as the technical phrase. The operation-end device 120 translates the technical phrase into the corresponding idiomatic sentence based on a translation table 330. In a condition that the technical sentence is “verify user identity”, the translated idiomatic sentence is “real-name identity”, and the translated idiomatic sentence can be combined with the preliminary search strategy to form the advanced search strategy, such as (metaverse)@AB AND (“real-name identity”). It is to be particularly noted that when there are at least two idiomatic sentences, at least one of the idiomatic sentences can be selected for combination.

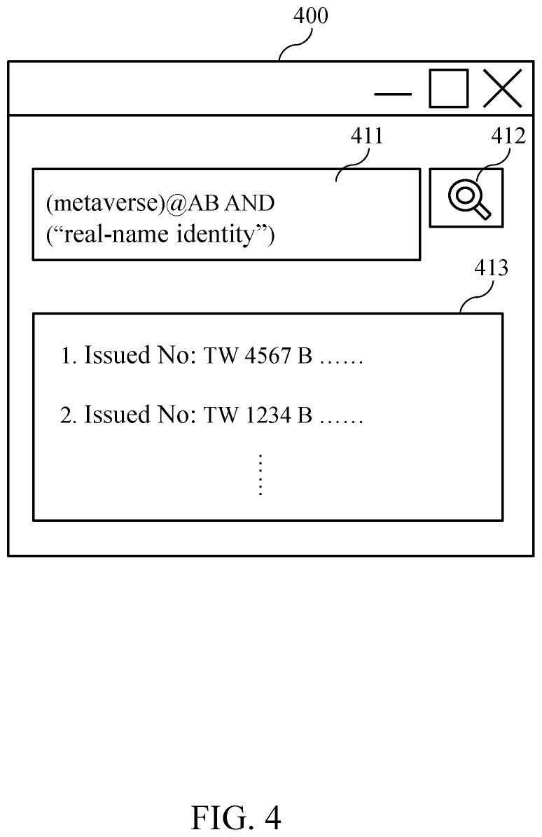

Please refer to FIG. 4. FIG. 4 is a schematic view of a patent search based on an advanced search strategy, according to an application of the present invention. In a condition that the formed advanced search strategy is “(metaverse)@AB AND (real-name identity)”, the operation-end device 120 can automatically input the advanced search strategy into the input block 411 of the search window 400, so that the user can click a search button 412 to perform search again, and the new search result is displayed on the display block 413. This search is performed with an additional limitation condition (that is, the “real-name identity”) than previous search; in other words, only the raw data of patent having the term “real-name identity” can be searched. In this way, the user can just use coarse key word as the preliminary search strategy in the first-time patent search, and the operation-end device 120 can automatically generate more accurate advanced search strategy for the user to perform accurate search, so as to effectively improve the accuracy of the patent search.

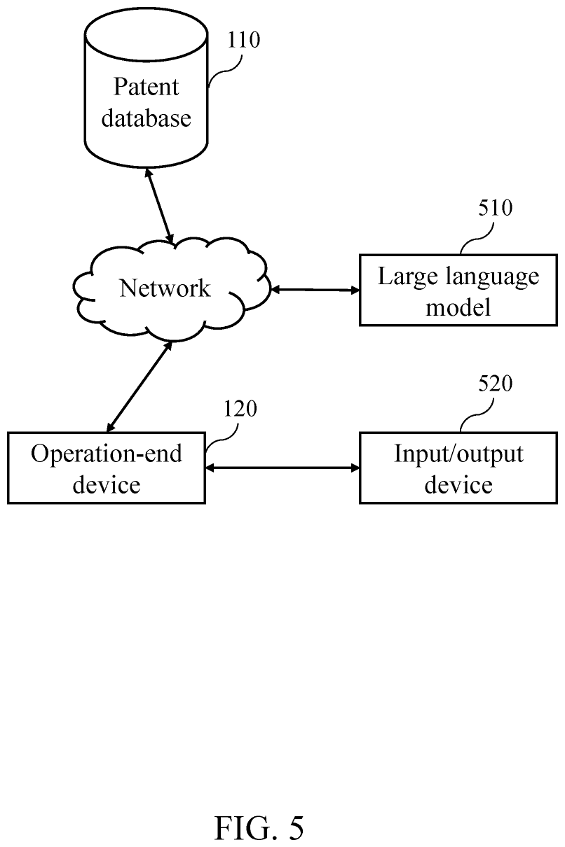

Please refer to FIG. 5. FIG. 5 is a schematic view of an operation of generating and updating a translation table, according to an application of the present invention. In actual implementation, the translation table includes a technical phrase and an idiomatic sentence corresponding to the technical phrase, and the manner of generating and updating the translation table can include using the operation-end device 120 to transmit the technical phrase to the large language model 510 in an external network through an application programming interface of the large language model 510, and receiving the corresponding idiomatic sentence from the large language model 510. In practice, besides technical phrase, the operation-end device 120 can also transmit a prompt which can be the technical field assigned by the user, such as a message about semiconductor field or computer graphics field, so that the operation-end device 120 can obtain the idiomatic sentence of the technical field to continuously write the technical phrase and the corresponding idiomatic sentence to the data table to generate and update the translation table. In addition, the user is permitted to freely label the technical phrase through an input/output device 520 (such as a mouse or a physical keyboard), and input the corresponding idiomatic sentence to generate and update the translation table. Using mouse is taken as example, the user can label the technical phrase by dragging and dropping a cursor; using a physical keyboard is taken as example, the user can label the technical phrase by clicking a function button and a direction key, and then input the idiomatic sentence corresponding to the labelled technical phrase through the physical keyboard. It is to be particularly noted that the translation table is permitted to share, and the translation tables generated by different generating and updating manners are permitted to synchronize with each other. For example, after the translation table recording “first technical phrase: first idiomatic sentence” is generated through a first manner, when the user wants to input “second technical phrase: second idiomatic sentence” through a second manner, the translation table can record “first technical phrase: first idiomatic sentence; second technical phrase: second idiomatic sentence” because the translation table can be shared to directly update the same translation table. In addition, when different translation tables are generated by different manners respectively, the two generated translation tables can record the same content after being synchronized, for example, “first technical phrase: first idiomatic sentence; second technical phrase: second two idiomatic sentences” because the translation table can be shared to directly update the same translation table.

According to above-mentioned contents, the difference between the present invention and the conventional technology is that, in the present invention, the operation-end device 120 can receive the preliminary search strategy, search the matching patent data from the patent database, and extract the patent classification from the searched patent data; the operation-end device is permitted to label the patent classification, and search the classification definition description message corresponding to the labelled patent classification, execute a natural language processing on the classification definition description message to perform tokenization and sentence segmentation, to filter out the technical phrase having the proper noun, so that the technical phrase can be translated into the idiomatic sentence based on the translation table, and the translated idiomatic sentence can be combined with the preliminary search strategy to automatically form an advanced search strategy, thereby achieving a technical effect of improving an accuracy of patent search.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A system for adjusting a search strategy based on a patent classification translation, comprising:
a patent database, configured to store one or more pieces of patent data; and
an operation-end device, connected to the patent database through a network, wherein the operation-end device comprises:
a non-transitory computer readable storage medium, configured to store computer readable instructions; and
a hardware processor, electrically connected to the non-transitory computer readable storage medium, and configured to execute the computer readable instructions to make the operation-end device execute:
receiving a preliminary search strategy, and transmitting the preliminary search strategy to the patent database to search one of the pieces of patent data matching the preliminary search strategy, and extracting at least one patent classification from the searched pieces of patent data;
permitting a labelling of the patent classification and querying a classification definition description message corresponding to the labelled patent classification, and executing a natural language processing on the classification definition description message, to perform a tokenization and sentence segmentation to generate one or more phrases;
analyzing a technical field corresponding to the patent classification, and filtering out at least one phrase, from the one or more phrases, having a proper noun of the technical field to be at least one technical phrase;
based on a translation table, translating the at least one technical phrase to at least one idiomatic sentence, selecting at least one of the at least one idiomatic sentence, and combining the selected idiomatic sentence with the preliminary search strategy to form an advanced search strategy; and
executing a search on the pieces of patent data based on the advanced search strategy, to filter out at least one piece of accurate patent data.

2. The system for adjusting a search strategy based on patent classification translation according to claim 1, wherein the patent classification is labelled by at least one of an automatic manner and a manual manner, to execute the natural language processing on the assigned classification definition description message.

3. The system for adjusting a search strategy based on patent classification translation according to claim 2, wherein the automatic manner of labelling the patent classification comprises collecting a cumulative quantity of the same patent classification and selecting the patent classification having the highest cumulative quantity to label.

4. The system for adjusting a search strategy based on patent classification translation according to claim 1, wherein the translation table is generated and updated by transmitting the technical phrase to a large language model, requesting the large language model to transmit back the corresponding idiomatic sentence, and generating and updating the translation table based on the technical phrase and the corresponding idiomatic sentence, wherein a user is permitted to freely label the technical phrase and input the idiomatic sentence corresponding to the labelled technical phrase to generate and update the translation table, wherein the translation table is permitted to be shared, and a plurality of translation tables generated and updated in different manners are permitted to be synchronized with each other.

5. The system for adjusting a search strategy based on patent classification translation according to claim 1, wherein the idiomatic sentence and the preliminary search strategy are combined as the advanced search strategy through a logical operator and a field code of bibliographic data associated with the patent.

6. A method for adjusting a search strategy based on patent classification translation, comprising:
connecting a patent database and an operation-end device through a network, wherein the patent database stores one or more pieces of patent data, the operation-end device comprises a non-transitory computer readable storage medium storing computer readable instructions, and a hardware processor configured to execute the computer readable instructions;
receiving a preliminary search strategy, and transmitting the preliminary search strategy to the patent database to search one of the pieces of patent data matching the preliminary search strategy, extracting at least one patent classification from the searched pieces of patent data, by the operation-end device;
permitting the operation-end device to label the patent classification, query a classification definition description message corresponding to the labelled patent classification, and execute a natural language processing on the classification definition description message to perform a tokenization and sentence segmentation to generate one or more phrases;
analyzing a technical field corresponding to the patent classification, and filtering out at least one phrase, from the one or more phrases, having a proper noun of the technical field to be at least one technical phrase, by the operation-end device;
based on a translation table, translating the technical phrase to at least one idiomatic sentence, selecting at least one of the at least one idiomatic sentence, and combining the selected idiomatic sentence with the preliminary search strategy to form an advanced search strategy, by the operation-end device; and
performing a search on the pieces of patent data based on the advanced search strategy again, to filter at least one piece of accurate patent data, by the operation-end device.

7. The method for adjusting a search strategy based on patent classification translation according to claim 6, wherein the patent classification is labelled by at least one of an automatic manner and a manual manner, to execute the natural language processing on the assigned classification definition description message.

8. The method for adjusting a search strategy based on patent classification translation according to claim 7, wherein the automatic manner of labelling the patent classification comprises collecting a cumulative quantity of the same patent classification and selecting the patent classification having the highest cumulative quantity to label.

9. The method for adjusting a search strategy based on patent classification translation according to claim 6, wherein the translation table is generated and updated by transmitting the technical phrase to a large language model, requesting the large language model to transmit back the corresponding idiomatic sentence, and generating and updating the translation table based on the technical phrase and the corresponding idiomatic sentence, wherein a user is permitted to freely label the technical phrase and input the idiomatic sentence corresponding to the labelled technical phrase to generate and update the translation table, wherein the translation table is permitted to be shared, and a plurality of translation tables generated and updated in different manners are permitted to be synchronized with each other.

10. The method for adjusting a search strategy based on patent classification translation according to claim 6, wherein the idiomatic sentence and the preliminary search strategy are combined as the advanced search strategy through a logical operator and a field code of bibliographic data associated with the patent.
